(19) United States
(12) Patent Application Publication
(10) Pub. No.: US 2009/0108094 A1
(43) Pub. Date: Apr. 30, 2009

(54) SYNTHETIC JET AIR FRESHENER

(75) Inventor: Yehuda Ivri, Newport Coast, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yehuda Ivri, Newport Coast, CA (US)

(21) Appl. No.: 12/255,051

(22) Filed: Oct. 21, 2008

Related U.S. Application Data
(60) Provisional application No. 60/999,994, filed on Oct. 23, 2007.

(51) Int. Cl. B05B 1/08

(52) U.S. Cl. 239/101

(57) ABSTRACT

An air freshening device comprises a housing defining a chamber. The chamber contains air and a supply of fragrance material that scents the air inside the chamber. A mechanical oscillator is in fluid communication with the air in the chamber and is configured to transmit acoustic waves in the chamber. A narrow conduit provides a passage from an interior of the chamber to the atmosphere outside the chamber. The conduit is dimensionally configured such that a synthetic jet from the narrow conduit is generated upon activation of the mechanical oscillator, the synthetic jet ejecting scented air from the chamber interior to the atmosphere outside the chamber. The mechanical oscillator may be driven intermittently, resulting in a consistent intensity and character of the emitted scent over the life of the product.

### CROSS-REFERENCES TO RELATED APPLICATIONS

This application claims priority to provisional application 60/999,994 of Ivri, titled “Synthetic Jet Air Freshener” and filed Oct. 23, 2007, and the entire disclosure of that application is hereby incorporated by reference herein.

### FIELD OF THE INVENTION

This invention relates to the field of dispensing scented air into the atmosphere and particularly but not exclusively for dispensing such material into small spaces such as fabric and linen storage compartments and the interior of motor vehicles.

### BACKGROUND OF THE INVENTION

Common air fresheners contain volatile substances that slowly evaporate to the atmosphere and emit scent to the surrounding space. The scented material in an air freshener may include a complex composition of many perfume raw materials of differing volatilities. Materials with higher volatilities tend to evaporate or diffuse into the surrounding air more quickly than materials with lower volatilities. Also, the rate of evaporation of a material tends to decay nonlinearly over time. As a result, highly volatile components of the air freshener material are released earlier than less volatile component. This produces inconsistent scent characteristics and intensity during the life of the air freshener. Stronger scents are emitted at the beginning of use and weaker scents predominate toward the end of the life of the product.

### BRIEF SUMMARY OF THE INVENTION

In accordance with one embodiment of the invention, an air freshening device comprises a housing defining a chamber. The chamber contains air and a supply of fragrance material that scents the air inside the chamber. A mechanical oscillator is in fluid communication with the air in the chamber and is configured to generate acoustic pressure in the chamber at a selected frequency. A narrow conduit provides a passage from an interior of the chamber to the atmosphere outside the chamber, and the conduit is dimensionally configured such that a synthetic jet from the narrow conduit is generated upon activation of the mechanical oscillator, the synthetic jet ejecting a jet of scented air from the chamber interior to the atmosphere outside the chamber. The narrow conduit may be configured to hinder diffusion of the fragrance material from the chamber during periods when the air freshening device is not ejecting a synthetic jet. The air freshening device may further comprise a control circuit that intermittently switches the mechanical oscillator on, and switches the mechanical oscillator off between periods when the mechanical oscillator is on. The fragrance material may scent the air inside the chamber by diffusion from the supply of fragrance material, and the periods of non-operation of the mechanical oscillator may be selected to be sufficiently long for the fragrance material to substantially fully scent the air in the chamber before the oscillator again oscillates. The selected frequency may be substantially a natural frequency of the mechanical oscillator. The selected frequency may be substantially a Helmholtz resonance frequency of the chamber. The mechanical oscillator may comprise a voice coil actuator driven by an electric frequency generator source. The mechanical oscillator may comprise an electromagnetic actuator driven by an electric frequency generator source. The mechanical oscillator may comprise a passive mechanical system that vibrates in response to motions imparted externally to the air freshening device, and the air freshening device may be mounted in a motor vehicle, and the motions imparted externally to the air freshening device are imparted by the motor vehicle. The air freshening device may further comprise a wick in fluid communication with a reservoir of fragrance material. The air freshening device may further comprise a replaceable strip that holds the fragrance material.

The air freshening device may further comprise at least one additional conduit, each additional conduit providing an additional passage from the interior of the chamber to the atmosphere outside the chamber. In this embodiment, each conduit is dimensionally configured such that a synthetic jet from each conduit is generated upon activation of the mechanical oscillator, and each synthetic jet ejects scented air from the chamber interior to the atmosphere outside the chamber.

The air freshening device may comprise two flow fields, wherein the first field is inside the chamber near the mechanical oscillator and is a substantially acoustic non-flowing field, and the second field is near the opening of the conduit and defines a flow field which produces a jet flow. The synthetic jet may comprise a stream of air which flows through the nozzle in two directions, wherein the first direction is from the chamber to the atmosphere and the second direction is from the atmosphere to the chamber.

In another embodiment, an odor absorbing device comprises a housing defining a chamber. The chamber contains air and a supply of an odor-absorbing material that absorbs odors from the air inside the chamber. A mechanical oscillator is in fluid communication with the air in the chamber and is configured to transmit acoustic waves in the chamber. A narrow conduit provides a passage from an interior of the chamber to the atmosphere outside the chamber. The conduit is dimensionally configured such that a synthetic jet from the narrow conduit is generated upon activation of the mechanical oscillator, the synthetic jet ejecting substantially odorless air from the chamber interior to the atmosphere outside the chamber.

In another embodiment, a method of freshening air comprises providing a housing that defines a chamber. The chamber contains air and a supply of fragrance material that scents the air inside the chamber. The housing also includes a narrow conduit providing a passage from an interior of the chamber to the atmosphere outside the chamber. The conduit is dimensionally configured such that a synthetic jet from the narrow conduit is generated upon activation of the mechanical oscillator, the synthetic jet ejecting scented air from the chamber interior to the atmosphere outside the chamber. The method further comprises providing a mechanical oscillator in fluid communication with the air in the chamber and configured to transmit pressure in the chamber at a selected frequency, and oscillating the mechanical oscillator.

In another embodiment, an actuator configured to dispense jets of scented air comprises a cavity storing an air freshening material therein. The cavity further comprises a narrow conduit that provides a passageway from an interior of the cavity to the atmosphere surrounding the actuator. A transducer is configured to generate sound pressure within the chamber at a selected frequency, thereby causing a jet of scented air to flow from the narrow conduit, and the jet is a synthetic jet.

In another embodiment, an air freshening device comprises a narrow nozzle through which a jet of scented air is dispensed from a chamber to the atmosphere outside the chamber. Air is received from the atmosphere into the chamber through the same narrow nozzle to replace the scented air dispensed from the chamber, and the jet is a synthetic jet. The narrow nozzle may be configured to hinder diffusion of fragrance material from the chamber to the atmosphere when the synthetic jet is not being dispensed. The nozzle may have a diameter of less than 2 millimeters, and may have a diameter of less than 1 millimeter.

In another embodiment, an air freshening device comprises a nozzle for cyclically ejecting scented air from a chamber to the surrounding space and receiving air from the surrounding space into the chamber. The nozzle is dimensionally configured to produce a synthetic jet and to limit diffusion of fragrance material from the chamber when the synthetic jet is not being produced.

### BRIEF DESCRIPTION OF THE DRAWINGS

FIG. 1 is a cross sectional view of an air freshening device in accordance with an embodiment of the invention.

FIG. 2 is a full side view of the air freshening device of FIG. 1.

FIG. 3 shows a schematic diagram of the air freshening device of FIG. 1, including a control circuit.

FIG. 4 shows a cross section view of another example air freshening device.

FIG. 5 shows a cross section view of an air freshening device in accordance with another embodiment of the invention.

FIG. 6 shows a perspective view of an air freshening device in accordance with another embodiment of the invention.

FIGS. 7A and 7B show a piezoelectric actuator with a feedback element, and a self-drive circuit, in accordance with an embodiment of the invention.

FIG. 8 shows a voice coil actuator, in accordance with an embodiment of the invention.

FIG. 9 shows an alternative drive circuit, in accordance with another example embodiment of the invention.

FIG. 10 shows a perspective view of an air freshening device in accordance with another embodiment of the invention.

FIG. 11 shows an exploded rear perspective view of the air freshening device of FIG. 10.

FIG. 11 shows an exploded front perspective view of the air freshening device of FIG. 10.

FIG. 13 illustrates an alternative embodiment for an electromagnet.

FIG. 14 shows an exploded view of the replaceable unit of the air freshening device of FIG. 10.

FIG. 15 illustrates an example net airflow pattern.

FIG. 16 illustrates a side view of an air freshening device according to another embodiment of the invention.

FIG. 17 shows a cross section view of the air freshening device of FIG. 16.

### DETAILED DESCRIPTION OF THE INVENTION

Embodiments of the invention utilize a synthetic jet actuator to produce a jet of scented air. A synthetic jet is an aeroacoustic phenomenon in which sound waves are used to induce the flow of a gas such as air. Synthetic jets were described in the literature as early as 1950, for example by Ingard and Labate, Acoustic Circulation Effects and the Nonlinear Impedance of Orifices, The Journal of the Acoustical Society of America, March 1950. In one simple arrangement, a synthetic jet may be generated from a chamber with a single small orifice at one end and an acoustic wave generating device such as a diaphragm at the other end. When acoustic waves are generated at certain frequencies and amplitudes by the acoustic wave generator, a jet of gas from the interior of the chamber will be produced flowing outward from the orifice. The jet may be produced with no net mass flux from the chamber. That is, gas escapes from the chamber when the diaphragm moves into the chamber, and, due to the dynamics of the airflow at the orifice, escapes away from the orifice. As the diaphragm moves back outward from the chamber, other ambient air is drawn into the chamber to replace the air that escaped in the jet. In this way, a jet may be developed emanating from a container with a single orifice. Multiple orifices may also be provided in a chamber and multiple jets formed.

A synthetic jet actuator may be seen as a device that converts acoustic sound pressure to air flow. Acoustic sound pressure generates vibration in the air near the mechanical oscillator inside the chamber. The vibration is a reversible motion of particles. The nozzle of the synthetic jet actuator increases the amplitude to the point that the sound wave becomes an irreversible fluid flow. Thus, the advantage of a synthetic jet air freshener is that it converts an acoustic field to a flow field. The acoustic field can be readily generated with a speaker or piezoelectric oscillator without the complexity normally associated with conventional pumps. A synthetic jet actuator does not use kinematics or pneumatic valves associated with other pumps.

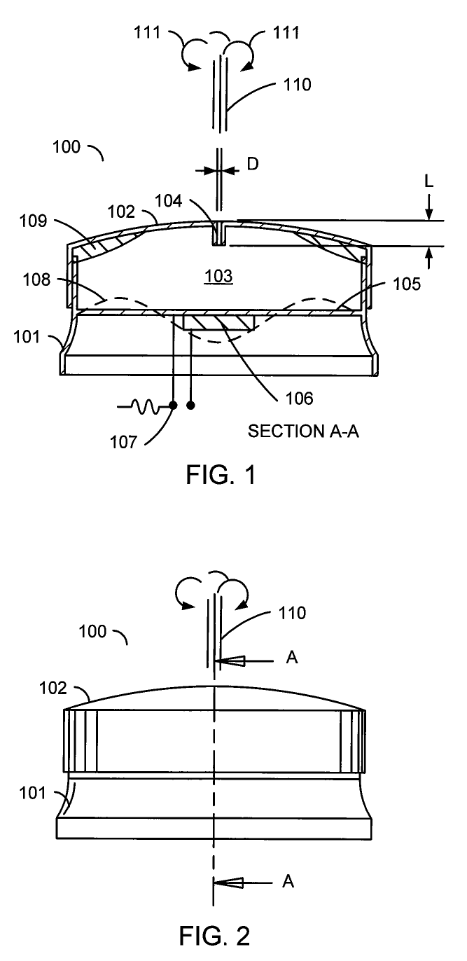

FIGS. 1 and 2 show a cross-sectional and a side view respectively of an air freshening device 100 according to an embodiment of the invention. Air freshening device 100 includes a housing that further comprises a base 101 and a cover 102. Base 101 and cover 102 define a generally cylindrical chamber 103. A narrow nozzle or conduit 104 provides a passage from the interior of chamber 103 to the atmosphere outside the chamber. A membrane 105 in the floor of chamber 103 is a mechanical oscillator in fluid communication with the air in chamber 103. In example air freshening device 100, membrane 105 is driven to oscillate by a piezoelectric transducer element 106. This kind of transducer assembly is referred to as a “unimorph”. Alternatively, a “bimorph” transducer assembly may be used. An oscillating electric voltage signal 107 drives piezoelectric transducer element 106 to vibrate, which in turn causes diaphragm 105 to vibrate. In one preferred embodiment diaphragm 105 vibrates in a second natural harmonic mode, as shown by dotted line 108. Piezoelectric transducer element 106 may be, for example, a type PZT-5A piezoelectric disk available from Morgan Matroc Electro-Ceramics, of Bedford, Ohio, USA.

Fragrance material 109 is disposed on the underside of cover 102. For example, fragrance material 109 may be a gel having a viscosity of about 300,000 to about 800,000 centipoise, and may include one or more aromatic compounds of varying volatilities. Fragrance material 109 may contain combinations of such components as aldehydes, ketones, esters, alcohol-terpenes, and various fragrance oils. Volatile compounds from fragrance material 109 evaporate or diffuse into the air in chamber 103, scenting the air in the chamber. In some embodiments, base 101 may be a fixed portion and cover 102, along with fragrance material 109, may be a replaceable portion, so that a new supply of fragrance material may be installed when fragrance material 109 has been consumed or if a change of fragrance is desired.

Conduit 104 is dimensionally configured such that when diaphragm 105 is vibrated, a jet 110 of scented air emanates from conduit 104. In one example embodiment, base 103 may be made of a thin carbon steel having a thickness of about 0.25 mm. Cover 102 may be made of a suitable thermoplastic polymer, such as a clear polymer of the polyester family. In one preferred embodiment, cover 102 is made of polyethylene terephthalate, also known as PET or PETE, and which is commonly used for storage of fragrance materials. The volume of chamber 103 may be, for example about 20 cubic centimeters. The diameter “D” of conduit 104 may be about 1.4 mm, and its length “L” may be about 5.0 mm. Diaphragm 105 may oscillate at about 1380 Hz. Of course, a wide range of other dimensions, materials, and operating frequencies are possible within the scope of the claims.

FIG. 1 also helps further illustrate the formation of a synthetic jet from conduit 104. When diaphragm 105 vibrates, air is alternately drawn into and expelled from conduit 104 as the volume of chamber 103 is alternately increased and decreased by diaphragm 105. For small vibrations, the air in conduit 104 may be envisioned as a vibrating “slug”, held in conduit by viscous forces. For larger and more energetic vibrations, the “slug” of air acquires enough inertia to overcome viscosity and separate from the nozzle to form jet 110. Vortices such as vortices 111 may form at the edges of the jet. The expelled air escapes into the atmosphere, and different air is drawn back into conduit 104 and chamber 103 by the return stroke of diaphragm 105.

Separation of the flow from the conduit occurs when the ratio of the inertial force and the viscosity of the air has reached a certain value. One criterion for the formation of a synthetic jet is based on the Reynolds number of the flow in the orifice. When the Reynolds number is defined as Re=Uj*h/ν (where Uj is the maximum jet velocity measured at the exit, h is the orifice diameter, and ν is the viscosity), a jet can develop when the Reynolds number exceeds about 50. See, for example, Wu and Breuer, Dynamics of Synthetic Jet Actuator Arrays for Flow Control, American Institute of Aeronautics and Astronautics, 2003, which paper is hereby incorporated by reference herein in its entirety. Another criterion is described by Utturkar et al., A Jet Formation Criterion for Synthetic Jet Actuators, presented at 41^{st} Aerospace Sciences Meeting & Exhibit of the American Institute of Aeronautics and Astronautics, 6-9 Jan. 2003, Reno, Nev., which paper is also hereby incorporated by reference herein in its entirety.

With this basic understanding of synthetic jets and the example air freshening device of FIGS. 1 and 2, several advantages of the system become apparent. Conduit 104 may be made quite small, and may have a significant length in relation to its diameter. The rate of unforced diffusion of materials from inside chamber 103 through conduit 104 to the ambient atmosphere is proportional to the diameter D of conduit 104 and inversely proportional to the square of the length “L” of conduit 104. In addition to the consideration of the Reynolds number as described earlier, the nozzle diameter (or its cross sectional area) and its length may be configured to minimize diffusion of air freshener material through the conduit. This provides a mechanism for turning the air freshening device “on” and “off”. When the mechanical oscillator is not actuated, the device is “off” and little scent escapes. When the mechanical oscillator is active, scented air is expelled into the environment. The conduit dimensions may be selected according to the diffusion coefficient and vapor pressure of the fragrance material being used. Preferably, diffusion of fragrance material during “off” periods of the dispenser is limited to less than 2 milligrams/hour, and more preferably to less than 1 milligram/hour, and even more preferably to less than 0.5 milligram/hour.

In perfumery chemistry, the perfume raw materials are classified according to their boiling temperature. Raw materials having boiling points below 250 C are generally classified as “top note” materials. These materials have high vapor pressures and tend to evaporate or diffuse relatively quickly. Less volatile materials, having boiling points above 250 C are referred to as “middle note” or “base note” materials. These materials have lower vapor pressures than the “top note” materials, and tend to evaporate or diffuse comparatively slowly. For example, a “top note” material may have a vapor pressure 1000 times as high as that of a “base note” material. Consequently, when the fragrance material comprises mostly volatile “top note” materials, a longer nozzle or conduit 104 may be used, and when the fragrance material comprises mainly “middle note” or “base note” materials, a shorter nozzle or conduit 104 may be used. In some embodiments, the length of conduit 104 may be between 0.1 mm and 25 mm, although other lengths are possible. The diameter of conduit 104 may be, for example, less than 5.0 mm, and preferably between 0.5 and 2.5 mm, and even more preferably between 0.7 and 1.75 mm.

A synthetic jet air freshening device embodying the invention may utilize any commercial air freshener composition. Particularly suitable are the evaporative type fragrance materials and aerosol type compositions such as those used in the Glade® Wisp® Flameless Candle air freshener made by SC Johnson of Racine, Wis., USA. Examples include materials commercially sold under the trade names Rainshower®, Clean Linen™, and French Vanilla. Other examples of fragrance materials suitable for use in embodiments of the invention include the gel material used in the product sold under the trade name “Aroma Ring Refill” by Method Products, Inc. of San Francisco, Calif., USA, including such scents as “Sweet Water”, “Fig”, and “Lavender”. Many other examples of fragrance materials suitable for use in embodiments of the invention are listed in U.S. patent application Ser. No. 10/137,529 of Welch et al., published as patent application publication 2003/0024977, and titled “Air Freshening Compositions, Articles Comprising Same and Methods”, which patent application is hereby incorporated by reference herein in its entirety for all purposes.

The mechanical oscillator may preferably be operated intermittently. In one mode of operation, the mechanical oscillator is left “off” for a period of time long enough that the fragrance material substantially reaches partial pressure equilibrium within the chamber, and the air in the chamber is substantially fully scented by the fragrance material. For example, the mechanical oscillator may be left “off” for a period of about 20 seconds. After a predetermined “off” interval, the mechanical oscillator is turned “on”, and scented air from the chamber is dispensed into the ambient atmosphere. For example, the oscillator may be turned “on” for a period of about 2.083 seconds. After a preselected “on” interval, the oscillator is again turned “off” and the fragrance material again allowed to diffuse into the chamber and substantially reach partial pressure equilibrium and to fully scent the air in the chamber. This cycle is repeated as long as desired. This technique has the advantage of making the strength or intensity of the dispensed scented air relatively constant over time, so long as the “off” intervals are sufficiently long to allow equilibrium within the chamber to be reached. Early in the life of the air freshening device, partial pressure equilibrium may be reached quickly during one of the “off” periods, but scented air is not dispensed until the end of the “off” period some time later (and little unforced diffusion of scent occurs from the device). Later in the life of the air freshening device, it may take longer for equilibrium to be reached, but substantially the same partial pressure of scent material will be reached inside the chamber, so long as each “off” interval is long enough, and therefore the scented air dispensed during the “on” periods will be essentially as strongly scented as it was early in the life of the air freshening device. The “on” and “off” intervals may be selected based on the characteristics of the fragrance materials used, the expected life of the air freshening device, and the application in which the air freshening device will be used.

Intermittent operation of the air freshening device may be especially advantageous when the fragrance material comprises a mixture of materials of differing volatilities. In a traditional air freshener having a combination of fragrance materials with differing volatilities, the scent of the freshener may be dominated early in the life of the freshener by any “top note” or other higher-volatility fragrance materials present. As the freshener ages and the “top note” materials lose strength, the scent may become dominated by the “middle note” and “base note” materials. In addition, all of the materials diffuse or evaporate during the life of the traditional freshener, so the overall strength of the scent provided by the freshener declines over time.

Both of these effects may be mitigated by the intermittent operation of the air freshening device according to embodiments of the invention. As is described above, the strength of the scent emitted by the air freshening device may be held relatively constant throughout the life of the air freshening device. In addition, the nature of the scent may also remain consistent, even if fragrance materials of differing volatilities are used. During “off” periods, the various fragrance materials evaporate or diffuse into the chamber until a state of partial pressure equilibrium is substantially reached. This process is described by the well-known Raoult's law. The more volatile components may reach equilibrium in the chamber more quickly than the less volatile components. Preferably, the “off” period of the intermittent operation is selected to be long enough to allow the least volatile component to substantially reach equilibrium. Loss of the more volatile components is substantially prevented by the geometry of the device that minimizes unforced diffusion of fragrance material out of the chamber. Once equilibrium is reached, the device dispenses the scented air in an “on” period, and the cycle repeats. In this way, rapid loss of the more volatile components is controlled, and even the very volatile components can remain present so that the nature of the scent emitted by the air freshening device remains consistent over time. Preferably, the quantities of the various fragrance materials used are selected so that they last approximately equal times, and no significant excess of any one fragrance material is present in the chamber when the other materials have been depleted.

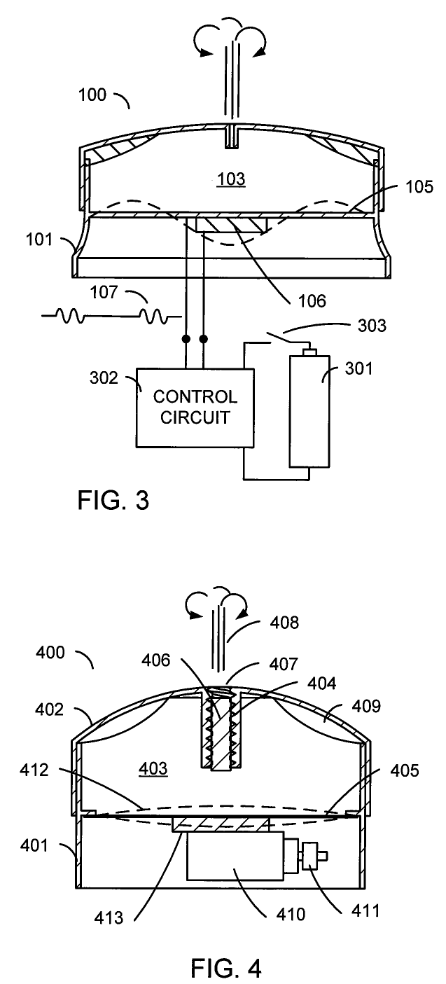

In some embodiments, a control circuit controls operation of the mechanical oscillator. For the purposes of this disclosure, a “mechanical oscillator” is a device that undergoes or produces reciprocating motions of one or more mechanical parts such as diaphragm 105. FIG. 3 shows a schematic diagram of a control circuit arrangement, based on example air freshening device 100. A battery 301 provides a power source for a control circuit 302, which produces an oscillating voltage 107 that drives piezoelectric transducer element 106, inducing vibration in membrane 105. Control circuit 302 may be implemented using analog electronics, digital electronics, a microprocessor-based control system, other kinds of circuitry, or any of these in any combination. A switch 303 may be included that allows turning the circuit and the air freshening device on and off. As is described above, voltage 107 is shown as both oscillating and intermittent, although it need not be intermittent. Control circuit 302 preferably provides a timing function, so that intermittent operation of the air freshener is possible. Additionally, an input dial, switch, knob, or other input device may be provided for enabling a user of the device to control the rate of dispensing of scented air, and therefore the strength or intensity of the scent in the area of the device. For example, 2, 3, 5, or another number of settings may be provided. In response to the setting of the input device, control circuit 302 may increase or decrease the lengths of the “off” and “on” periods. Preferably, battery 301 and control circuit 302 are integrated into the air freshening device, for example residing in the underside of base 101 of device 100.

Preferably, the dimensions of the air freshening device, such as device 100, are selected so that the mechanical oscillator operates at a resonant frequency of the chamber. Operating at a resonant frequency may minimize the amount of power required to operate the air freshening device. Conveniently, this may be a Helmholtz frequency. Helmholtz resonance is a phenomenon of air resonance in a cavity with a relatively small opening. Air oscillating in the opening, such as conduit 104, may be thought of as a “slug” of air with a mass and consequent inertia. The air inside the cavity behaves as a spring, because as air moves into the opening, the pressure in the cavity rises, making it more difficult to move additional air into the opening. The system is then analogous to a spring-mass system, and has a characteristic resonant frequency. The resonant frequency is related to the amount of air in the nozzle of conduit, the volume of the cavity, and the characteristics of the air or other working fluid, but is substantially insensitive to the shape of the cavity. The Helmholtz resonant frequency of cavity 103 shown in FIG. 1 may be approximated by

$${f}_{1} = \frac{v}{2 π} \sqrt{\frac{A}{{V}_{0} L}}$$

where v is the speed of sound (about 343 meters/sec in air), A is the cross sectional area of conduit 104, V₀ is the volume of chamber 103, and L is the length of conduit 104. More accurate estimates of the resonant frequency of a particular device may be obtained by numerical computation such as finite element analysis, or by experimental measurements.

Preferably, the device dimensions are selected to avoid operation at frequencies that result in unpleasant acoustical properties of the device. For example, an air freshener oscillator may be configured to operate at a frequency above 20 KHz, or below 20 Hz, so that the device emits little or no sound audible to humans. Alternatively, relatively low operational frequencies may be used, for example, below 1 KHz, or preferably below 300 Hz, or more preferably below 200 Hz.

In one example embodiment, the volume of chamber 103 is 20 cubic centimeters (2×10⁻⁵ m³), the diameter of conduit 104 is 1.4 mm (1.4×10⁻³ m), and the length of the conduit is 5 mm (5×10⁻³ m). The area A of conduit 104 is then π/4×(1.4×10⁻³)²=1.53×10⁻⁶ m². The Helmholtz frequency of the chamber is then about 214 Hz.

During operation, vibration may be imparted to the housing components of an air freshening device, for example base 101 of device 100. In such cases it is preferable to provide vibration absorbing mounting pads to minimize the transmission of vibratory noise from the base of the device to the surface upon which it is placed.

Many variations in the dimensions, materials, and components are possible within the scope of the appended claims. It is to be understood that the embodiments described above and the components described in more detail below are exemplary only, and that variations may be used in any compatible combination.

FIG. 4 shows a cross section view of another example air freshening device 400. Air freshening device 400 includes a base 401 and cover 402, which cooperate with membrane 405 to define a chamber 403. Vibration of membrane 405 alternately draws air in and out of the chamber through conduit 404, emitting from nozzle 407 a synthetic jet 408 of air that has been scented by fragrance material 409. A narrow conduit 404 allows passage of the scented air to the nozzle. Conduit 404 is helical, and is conveniently formed between a helical groove or thread in cover 402 and a pin 406 inserted into cover 402. A helical conduit has the characteristic that it forms a relatively long, narrow passageway in a small space. As has been explained above, a long conduit slows evaporation and diffusion of materials from chamber 403, and may be especially suited for dispensing highly volatile scent materials, or mixtures of fragrance materials of varying volatilities.

Air freshening device 400 also uses a different mechanical oscillator than did air freshening device 100. In air freshening device 400, a motor 410 includes an unbalanced or eccentric mass 411 on the motor shaft. When motor 410 rotates, its unbalanced weight 401 causes vibration, exciting vibration of membrane 405. In some embodiments, the system is tuned so that the motor vibrates at a resonant or natural frequency of membrane 405. A first harmonic vibration mode is illustrated in FIG. 4 by dotted line 412, representing the extremes of motion of membrane 405 during vibration. The resonant frequency will depend on several factors, including the dimensions and stiffness of membrane 405, and the weight of motor 410. Operating at a resonant frequency may reduce the amount of power required to operate air freshening device 400. In some embodiments, the resonant frequency of the mechanical oscillator system may be selected to match the resonant frequency of the chamber, and may be selected based on the desired air velocity in the nozzle. A higher air velocity produces more flow of scented air. In some cases, the resonant frequency of the drive system may be adjusted by adding mass, such as pillow block 413. In one example embodiment, motor 410 rotates at about 100 rotations per second, and pillow block 413 weights about 15 grams. Motor 410 may be controlled by a control circuit that may include timer circuitry to produce intermittent operation of air freshening device 400. The circuit and motor may be powered, for example, by a size “AA” battery that produces about 1.5 volts. Many other kinds of batteries may be used, and other power sources may be used, as described below.

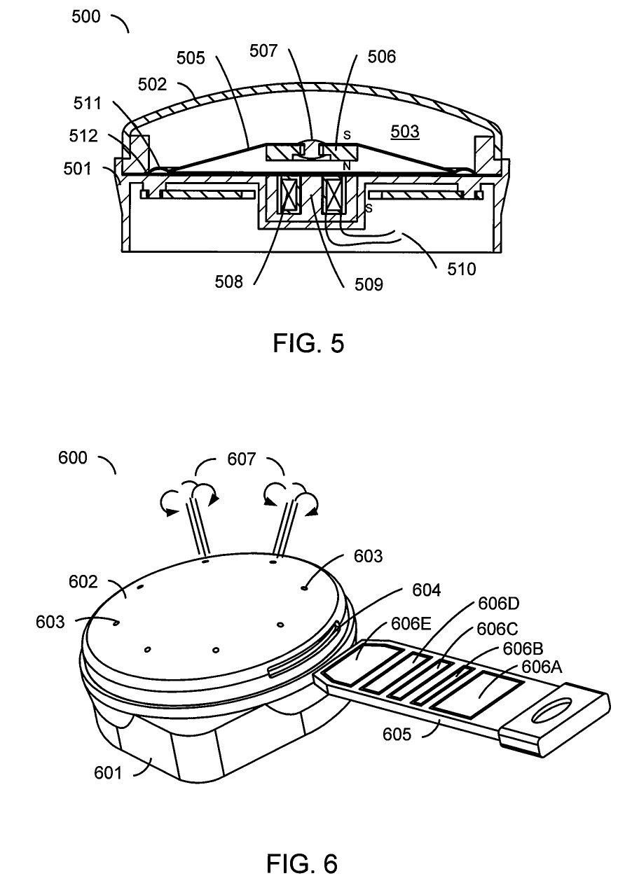

FIG. 5 shows a cross section view of an air freshening device 500 in accordance with another embodiment of the invention. This embodiment illustrates yet another kind of mechanical oscillator and drive circuit that may be included. Air freshening device 500 includes a base 501 and a cover 502. In this example, cover 502 is part of a replaceable portion that also includes vibrateable membrane 505 and a magnet member 506 connected to membrane 505, for example by a rivet 507. The replaceable portion also includes chamber 503, and a supply of fragrance material (not shown) in the chamber 503. One or more apertures or conduits (also not shown in this view) provide a passageway or passageways for air to enter and exit the chamber 503. An electromagnet coil 508 is wound around a core 509. When electric current is passed through coil 508 via leads 510, magnet member 506 will be drawn toward or repelled from coil 508, depending on the direction of current flow in coil 508. By passing an alternating current through coil 508, magnet member 506 may be made to vibrate, along with membrane 505, thus providing the acoustic drive that creates synthetic jets from the apertures or conduits.

Preferably, the system is tuned to take advantage of one or more resonant or natural frequencies, so as to minimize the amount of power required to drive the system. Diaphragm 505 may be driven at the resonant frequency of chamber 503, for example the Helmholtz frequency. Membrane 505 and magnet member 506 may be configured and selected so that a resonant or natural frequency of the membrane corresponds to the resonant frequency of the chamber. And a drive circuit for providing the alternating current to coil 508 may itself have a resonant or natural frequency, which may be selected or tuned to correspond to other resonances in they system. Any one of the resonant frequencies may be considered to be an “anchor” frequency, and the other components adapted to conform to that anchor frequency. For example, the size of chamber 503 may be fixed by design considerations, so that the resonant frequency of the chamber is not easily adjustable. In that case, membrane 505 and the drive circuit may be adjusted to conform to that frequency.

For example, membrane 505 has an inverted cone shape, similar in shape to a voice coil speaker. The center cone is relatively stiff, and a relatively flexible annular groove 511 is provided around the periphery 512 of membrane 505. This configuration produces strong acoustic pressures. The weight of magnet member 506 may also be selected to adjust the natural frequency of membrane 505 to a desired value. In one embodiment, the natural frequency of membrane 505 may be about 100 Hz.

A power source and control circuit for coil 508 may reside in base 501, and may be similar to battery 301 and control circuit 302 previously described. Alternatively, air freshening device 500 may be configured to connect directly to a mains power outlet, as is described below.

FIG. 6 shows a perspective view of an air freshening device 600 in accordance with another embodiment of the invention. Air freshening device 600 comprises a base 601 and cover 602. Nozzles or conduits 603 are arranged circularly around the edges of cover 602, and provide passages for air between an internal chamber and the atmosphere outside air freshening device 600. Air freshening device 600 also may include other components not visible in FIG. 6, including a mechanical oscillator, a power source, a control circuit, or other components. Air freshening device 600 is configured so that synthetic jets 607 of scented air are emitted during operation from nozzles or conduits 603. Cover 602 includes an open slot 604, into which a carrier or coupon 605 may be inserted. Carrier or coupon 605 includes one or more supplies of fragrance materials. In the example of FIG. 6, carrier 605 includes five different supplies of fragrance material, 606A-606E. Carrier 605 may be made, for example, of a molded polymer or another suitable material. Fragrance material supplies 606A-606E may be absorbed areas of carrier 605 made of absorbent polyethylene, may be supplies of gel containing fragrance material, or may be supplied in a different manner. The supplies may contain different quantities of fragrance materials. For example, large section 606A may contain a less volatile fragrance material, and small section 606B may contain a more volatile fragrance material. Carrier 605 is conveniently removed and replaced when the materials have been depleted by use of air freshening device 600.

Each of nozzles or conduits 603 is dimensionally configured to meet the criterion for formation of a synthetic jet. The nozzles or conduits 603 may also be sized, in conjunction with other elements, so that a desired Helmholtz resonant frequency is attained for the chamber.

Various driving and control circuits may be used in embodiments of the invention to provide a frequency generator source for the oscillator. Advantageously, the control circuit is configured to oscillate the acoustic wave generator at the natural frequency of the acoustic wave generator. One way to accomplish this is to use a “self drive circuit”. Such a circuit is widely used in piezoelectric buzzers. A self drive circuit includes a feedback sensor the detects the oscillator position and switches the drive on and off at appropriate times in the oscillation cycle to reinforce the oscillation. If the mechanical oscillator is a piezoelectric diaphragm, a feedback electrode is preferably included on the diaphragm, separate from the driving piezoelectric element.

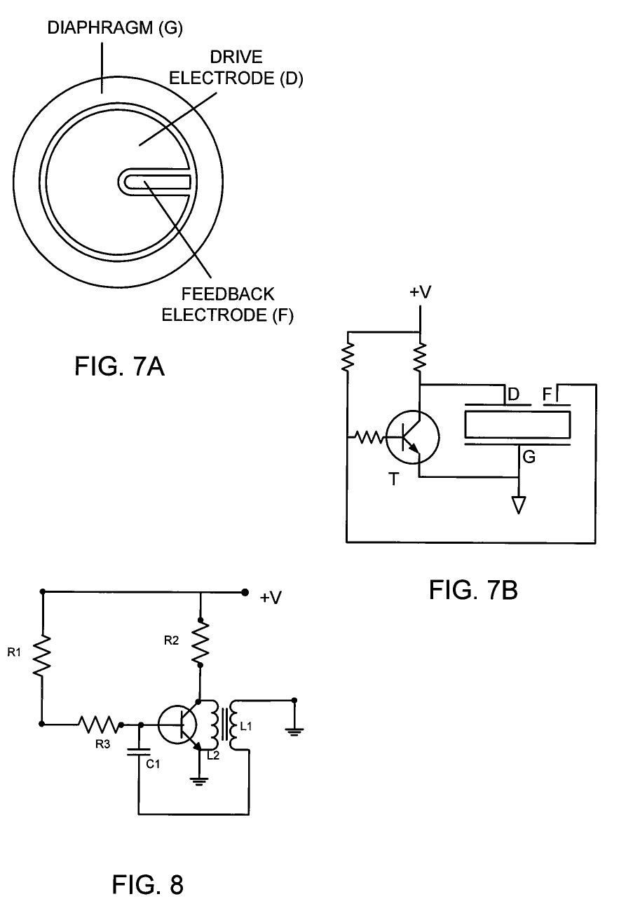

FIGS. 7A and 7B show a piezoelectric actuator with a feedback element, and a self-drive circuit, in accordance with an embodiment of the invention. More information about such circuits may be found in the Piezoelectric Sound Components Application Manual, available from Murata Manufacturing Co., Ltd., which manual is hereby incorporated by reference herein. In FIG. 7A, each of drive electrode D and feedback electrode F is piezoelectric material, such as polyvinylidene fluoride. Oscillating voltage supplied to drive electrode D will oscillate diaphragm G. In response, feedback electrode F produces a voltage indicating the motion of diaphragm G. When the voltage produced by feedback electrode F is high, transistor T turns on, lowering the voltage on drive electrode D. When the voltage produced by feedback electrode F is low, transistor T turns off so that voltage +V is essentially applied to drive electrode D. Thus, the voltage applied to drive electrode D is switched by the motion of diaphragm G itself.

A self-drive circuit may also be used in conjunction with a voice coil drive, such as is shown in FIG. 5. In this case, feedback would be provided by a secondary feedback coil. The main driving coil is used to apply the oscillation force and the secondary feedback coil switches off the main driving coil based on movement of the driving coil. Such a system will automatically find the natural frequency of the mechanical oscillation system. A self-drive circuit for a voice coil actuator is shown in FIG. 8. This circuit is analogous to the circuit of FIG. 7B, except that coil L2 is the driving element, and coil L1 provides feedback to switch the transistor in response to motion of L2.

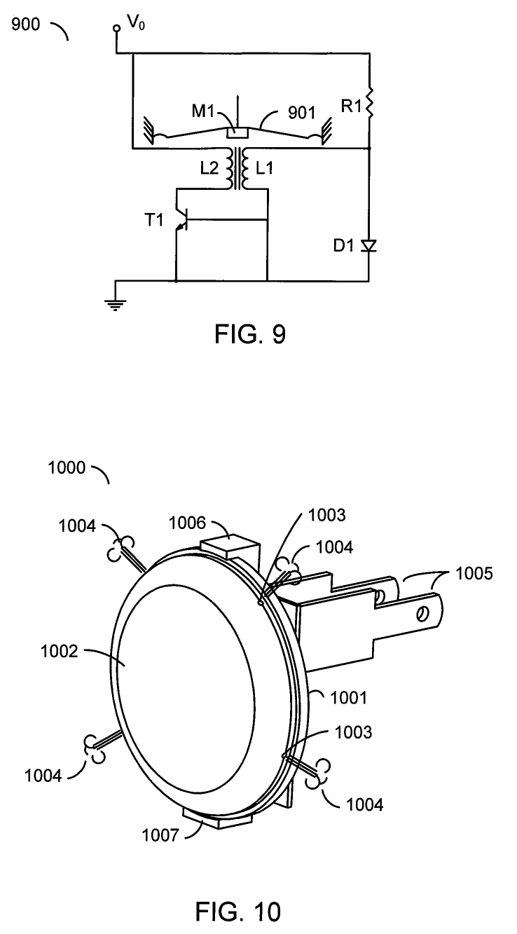

FIG. 9 shows an alternative drive circuit 900, in accordance with another example embodiment of the invention. When the voltage is switched over V₀, current flows thru R1 and L1. This causes a momentary rise and fall in voltage across coil L1, which is the typical response of an inductor to an instantaneous change in the current passing through it. This rise and fall is used to switch transistor T1 “on” momentarily and back “off”, causing a momentary current flow thru L2, and developing electromagnetic force which pulls magnet M1 and the membrane 901 toward coil L2. The cycle repeats as soon as transistor T1 turns off. The operating frequency depends of the value of L1 and R1. This embodiment has the advantage that the circuit has very few components and is therefore inexpensive.

FIGS. 10-14 illustrate views of an air freshening device 1000 in accordance with another embodiment of the invention. Air freshening device 1000 is configured to receive power directly from a mains power source, such as a wall outlet, and to use the electric line frequency to impart oscillation to the mechanical oscillator for generating the synthetic jet. Power from the mains is typically alternating current (AC) supplied at a particular voltage and frequency that depends on the country in which the power is supplied. For example, in the United States, residential power is typically supplied at about 120 V, 60 Hz. In Europe, power is typically supplied at about 230 V, 50 Hz.

FIG. 10 shows a perspective view of air freshening device 1000. Air freshening device 1000 includes a chamber formed by a vibrateable membrane 1001 and a cover 1002. The chamber contains a supply of fragrance material to be dispensed through one or more nozzles or conduits 1003, which provide passage for scented air to be dispensed from the chamber in the form of synthetic jets 1004 induced by the motion of vibrateable member 1001. Air freshening device 1000 also includes plugs 1005 for receiving power from a mains power source. Plugs 1005 are shown as type “A” plugs common in the United States, but other kinds of plugs may be used in other areas. Preferably vibrateable membrane 1001 and cover 1002 and the chamber they define are a replaceable unit. Attachment clips 1006 and 1007 hold the replaceable unit into the device.

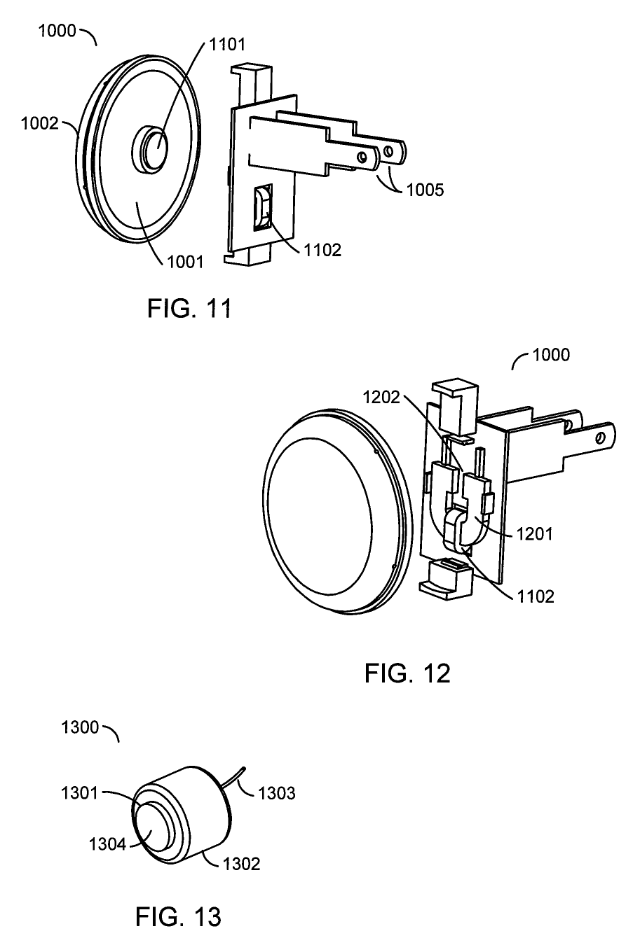

FIG. 11 shows an exploded rear perspective view of air freshening device 1000. Vibrateable membrane 1001 and cover 1002 are comprised in a replaceable unit. A ferromagnetic plate 1101 is mounted near the center of vibrateable membrane 1001. An electromagnet 1102 receiving power from plugs 1005 produces an alternating magnetic field which vibrates the ferromagnetic plate 1101 at the mains power frequency. Additional enclosure elements may be present to shield or insulate plugs 1005.

FIG. 12 shows an exploded front perspective view of air freshening device 1000. Electromagnet coil 1101 is wrapped around core 1201 such that magnetic flux lines pass through core 1201 and through air gap 1202. Ferromagnetic plate 1101 (shown in FIG. 11) is positioned in close proximity to air gap 1202 and is in alignment with air gap 1202. An alternating magnetic force is developed which causes ferromagnetic plate 1101, and consequently membrane 1001, to vibrate at the mains power frequency.

FIG. 13 illustrates an alternative embodiment for an electromagnet 1300, for example for use in air freshening device 1000. Electromagnet 1300 comprises an iron core 1301 and a coil 1302. Coil 1301 is wound around the core 1301 and is connected to the mains power source through electric wire 1303. Core 1301 may be made of a round ferromagnetic bar. In one example embodiment, core 1301 has a diameter of about 8 mm and a length of about 12 mm. In use, core 1301 is axially aligned with ferromagnetic plate 1101 such that the distance between plate 1101 and a face 1304 of core 1301 may be about 1 mm to 3 mm. An alternating current from the mains power source produces a magnetic field in core 1301 and through plate 1101. An alternating magnetic force vibrates the ferromagnetic plate 1101 and membrane 1001, which are integrally connected with each other. In a preferred embodiment, the impedance of coil 1302 is about 2 mH, and the natural frequency of membrane 1001 is about 60 Hz.

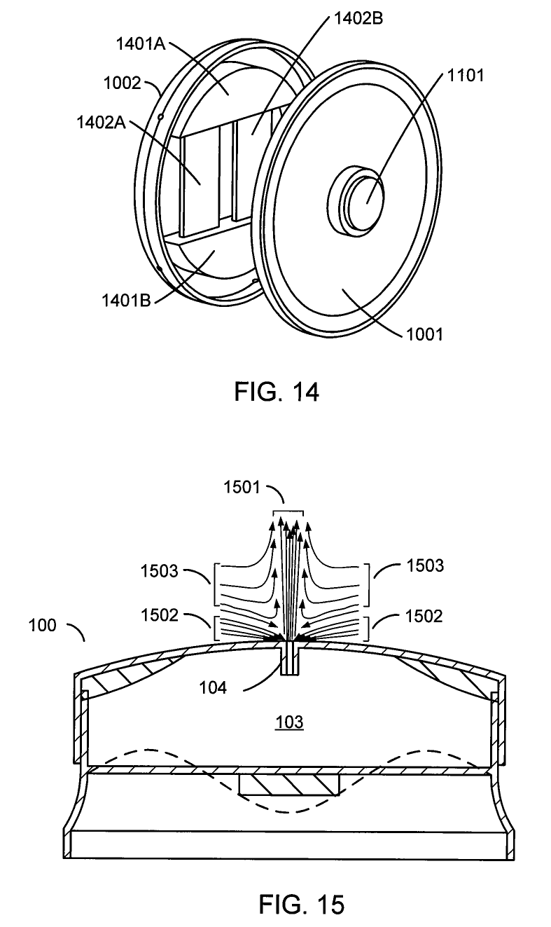

FIG. 14 shows an exploded rear perspective view of the replaceable unit of air freshening device 1000, including vibrateable membrane 1001 and cover 1002, which define a chamber. In FIG. 14, some internal features of the chamber are visible, including elements for storing and controlling the fragrance material held inside the chamber. Cover 1002 incorporates one or more containers 1401A and 1401B that contain fragrance material in a liquid state. One or more wicks 1402A and 1402B are in fluid communication with the liquid in containers 1401A and 1401B, and draw liquid from the containers into the main part of the chamber, where it is free to evaporate or diffuse into the chamber. Preferably, the wick is made of hydrophilic porous polypropylene material having a pore size of about 90 to 130 microns, or another suitable material. Such material is sold by Small Parts Inc., of Miramar, Fla. USA. Preferably, the volume of liquid in the device is smaller than the combined volume of containers 1401A and 1401B, and the air freshening device may be held in any orientation with respect to gravity without leakage of any fluid into the chamber. Liquid may flow between the chambers as necessary to avoid spillage.

Conveniently, intermittent operation of an air freshening device using an electromagnetic actuator may be accomplished using a temperature-sensitive switch, such as a resettable thermoelectric switch. The electromagnet tends to heat up during “on” periods. The thermoelectric switch is in contact with the electromagnet so that the switch senses the temperature of the electromagnet. When a predetermined temperature threshold is reached, the switch breaks the electric circuit driving the electromagnet, and the device is switched off and the electromagnet begins cooling. When a second temperature threshold is reached, the thermoelectric switch reengages the electric circuit, and the device is switched on. A design for a resettable thermal switch is presented in U.S. Pat. No. 4,118,683 to Schwarz, and that patent is hereby incorporated by reference herein in its entirety.

FIG. 15 illustrates an example net airflow pattern developed as air is ejected via synthetic jet from chamber 103 through conduit 104 of example air freshening device 100. In many cases, the flow field will be generally axisymmetric about the axis of the conduit, and the vectors shown in FIG. 15 represent a cross section of the flow field. Scented air ejected from chamber 103 via conduit 104 escapes the area in a synthetic jet, indicated by vector bundle 1501. The ejected air is replaced by air flowing in from the ambient environment, illustrated by vector bundles 1502. Some ambient air, represented by vector bundles 1503, is drawn by the jet away from the air freshening device, but of course, this air is not scented in the way that air from chamber 103 is. Vector bundles 1501-1503 illustrate net flows. The flow in the vicinity of nozzle or conduit 104 maybe quite complex, and the flow in conduit 104 is oscillatory.

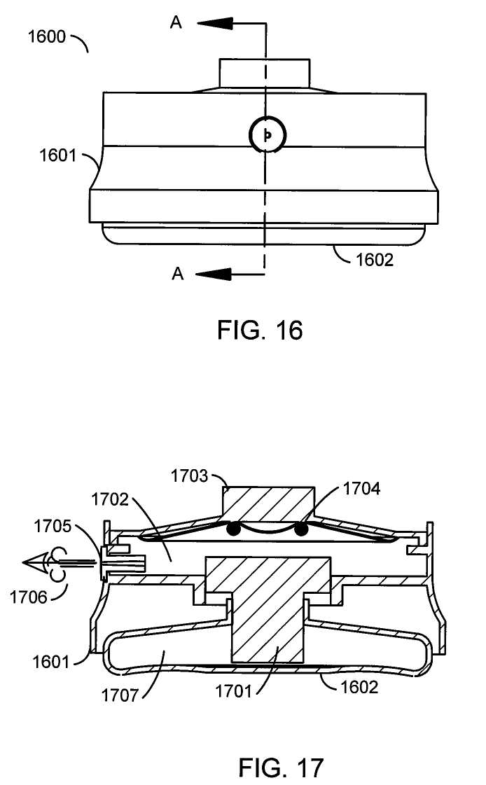

FIG. 16 shows a side view of an air freshening device 1600 in accordance with another embodiment of the invention, and FIG. 17 shows a cross section view of the device of FIG. 16. This air freshening device is configured to receive fragrance material from a liquid reservoir 1602 that resides in base 1601. As shown in FIG. 17, liquid is drawn from reservoir 1602 by wick 1701 into chamber 1702, where it evaporates or diffuses into the air. A modified audio speaker 1703 is electrically driven and acts as a mechanical oscillator, providing acoustic excitation of the air in chamber 1702. A metal ring 1704 has been added to speaker 1703 to adjust the natural resonant frequency of the speaker, for example to about 120 Hz. Nozzle 1705 is dimensionally configured such that a synthetic jet 1706 is developed when speaker 1703 is operating, dispensing scented air from chamber 1702 to the ambient atmosphere. Liquid reservoir 1602 is preferably replaceable, so that the supply of liquid fragrance material 1707 may be replenished when it is depleted by use of the device.

In another embodiment, the mechanical oscillator of an air freshener device may be excited by motions imparted externally to the device. For example, the device may comprise a passive spring-mass system tuned to preferentially vibrate at an appropriate frequency when excited externally. In one example, the natural frequency of the spring-mass system may be selected to be a frequency that will generate a synthetic jet from the chamber. This kind of system may be especially suited to use in a car or other moving environment. The motions of the vehicle tend to excite vibration of the mechanical oscillator, thereby dispensing fragrance when the car is in motion.

In another embodiment, an air freshening device including a synthetic jet generator may freshen air by removing odors, rather than adding fragrance material. The construction and operation of such a device may be similar to any of the devices already described, except that the chamber of the device may hold a supply of odor-absorbing material rather than fragrance material. The odor-absorbing material may be, for example, sodium bicarbonate or active carbon. This kind of device may be especially suited for removing odors from small enclosed spaces such as food storage cabinets, refrigerators, areas near pet litter boxes, and the like.

In operation, the device would expel air from its chamber via a synthetic jet as has been described. In the process, it draws odor-containing air from the surrounding environment. Within the chamber, the odor-containing air is exposed to the odor-absorbing material, and becomes deodorized, and is then ejected to the ambient atmosphere. The device may be operated intermittently, so that air in the chamber may become thoroughly deodorized before being ejected.

While embodiments of the invention have been described, it is to be understood that the invention is not limited to a particular embodiment or application, or to the dispensing of a particular kind of fragrance material. The device may utilize fragrance materials in solid or liquid form, including gels and powders. The device be scaled up or down in size for particular applications, for example for use with video or audio equipment, mobile telephones, or wearable devices. For example, an array of scent dispensing devices according to embodiments of the invention and containing a variety of scents may be controlled and utilized by a video gaming system or computer, and may dispense scents under control of the video gaming system or computer.

### INDUSTRIAL APPLICABILITY

The scent dispensing actuator of the can be use to forcefully dispense a jet of scented air over an extended period of time, with the advantage of producing a consistent scent composition and intensity during the life of the product.

What is claimed is:

1. An air freshening device, comprising:
a housing defining a chamber, the chamber containing air and a supply of fragrance material that scents the air inside the chamber;
a mechanical oscillator in fluid communication with the air in the chamber and configured to generate acoustic pressure in the chamber at a selected frequency; and
a narrow conduit providing a passage from an interior of the chamber to the atmosphere outside the chamber, wherein the conduit is dimensionally configured such that a synthetic jet from the narrow conduit is generated upon activation of the mechanical oscillator, the synthetic jet ejecting a jet of scented air from the chamber interior to the atmosphere outside the chamber.

2. The air freshening device of claim 1, wherein the narrow conduit is configured to hinder diffusion of the fragrance material from the chamber during periods when the air freshening device is not ejecting a synthetic jet.

3. The air freshening device of claim 1, further comprising a control circuit that intermittently switches the mechanical oscillator on, and switches the mechanical oscillator off between periods when the mechanical oscillator is on.

4. The air freshening device of claim 3, wherein the fragrance material scents the air inside the chamber by diffusion from the supply of fragrance material, and wherein periods of non-operation of the mechanical oscillator are selected to be sufficiently long for the fragrance material to substantially fully scent the air in the chamber before the oscillator again oscillates.

5. The air freshening device of claim 1, wherein the selected frequency is substantially a natural frequency of the mechanical oscillator.

6. The air freshening device of claim 1, wherein the selected frequency is substantially a Helmholtz resonance frequency of the chamber.

7. The air freshening device of claim 1, wherein the mechanical oscillator comprises a voice coil actuator driven by an electric frequency generator source.

8. The air freshening device of claim 1, wherein the mechanical oscillator comprises an electromagnetic actuator driven by an electric frequency generator source.

9. The air freshening device of claim 1, wherein the mechanical oscillator comprises a passive mechanical system that vibrates in response to motions imparted externally to the air freshening device, and wherein the air freshening device is mounted in a motor vehicle, and the motions imparted externally to the air freshening device are imparted by the motor vehicle

10. The air freshening device of claim 1, further comprising a wick in fluid communication with a reservoir of fragrance material.

11. The air freshening device of claim 1, wherein further comprising a replaceable strip that holds the fragrance material.

12. The air freshening device of claim 1, further comprising at least one additional conduit, each additional conduit providing an additional passage from the interior of the chamber to the atmosphere outside the chamber, wherein each conduit is dimensionally configured such that a synthetic jet from each conduit is generated upon activation of the mechanical oscillator, each synthetic jet ejecting scented air from the chamber interior to the atmosphere outside the chamber.

13. The air freshening device of claim 1, comprising two flow fields, wherein the first field is inside the chamber near the mechanical oscillator and is a substantially acoustic non-flowing field, and the second field is near the opening of the conduit and defines a flow field which produces a jet flow.

14. The air freshening device of claim 1, wherein the synthetic jet comprises a stream of air which flows through the nozzle in two directions, wherein the first direction is from the chamber to the atmosphere and the second direction is from the atmosphere to the chamber.

15. An odor absorbing device, comprising:
a housing defining a chamber, the chamber containing air and a supply of an odor-absorbing material that absorbs odors from the air inside the chamber;
a mechanical oscillator in fluid communication with the air in the chamber and configured to transmit acoustic waves in the chamber; and
a narrow conduit providing a passage from an interior of the chamber to the atmosphere outside the chamber, wherein the conduit is dimensionally configured such that a synthetic jet from the narrow conduit is generated upon activation of the mechanical oscillator, the synthetic jet ejecting substantially odorless air from the chamber interior to the atmosphere outside the chamber.

16. A method of freshening air, the method comprising:
providing a housing that defines a chamber, the chamber containing air and a supply of fragrance material that scents the air inside the chamber, wherein the housing includes a narrow conduit providing a passage from an interior of the chamber to the atmosphere outside the chamber, wherein the conduit is dimensionally configured such that a synthetic jet from the narrow conduit is generated upon activation of the mechanical oscillator, the synthetic jet ejecting scented air from the chamber interior to the atmosphere outside the chamber;
providing a mechanical oscillator in fluid communication with the air in the chamber and configured to transmit pressure in the chamber at a selected frequency; and
oscillating the mechanical oscillator.

17. An actuator configured to dispense jets of scented air, the actuator comprising:
a cavity storing an air freshening material therein, the cavity further comprising a narrow conduit that provides a passageway from an interior of the cavity to the atmosphere surrounding the actuator; and
a transducer configured to generate sound pressure within the chamber at a selected frequency, thereby causing a jet of scented air to flow from the narrow conduit;
wherein the jet is a synthetic jet.

18. An air freshening device, comprising a narrow nozzle through which a jet of scented air is dispensed from a chamber to the atmosphere outside the chamber, wherein air is received from the atmosphere into the chamber through the same narrow nozzle to replace the scented air dispensed from the chamber, and wherein the jet is a synthetic jet.

19. The air freshening device of claim 18, wherein the narrow nozzle is configured to hinder diffusion of fragrance material from the chamber to the atmosphere when the synthetic jet is not being dispensed.

20. The air freshening device of claim 19, wherein the nozzle has a diameter of less than 2 millimeters.

21. The air freshening device of claim 19, wherein the nozzle has a diameter of less than 1 millimeter.

22. An air freshening device, comprising:
a nozzle for cyclically ejecting scented air from a chamber to the surrounding space and receiving air from the surrounding space into the chamber, wherein the nozzle is dimensionally configured to produce a synthetic jet and to limit diffusion of fragrance material from the chamber when the synthetic jet is not being produced.
